(19) United States
(12) Patent Application Publication
(10) Pub. No.: US 2023/0121456 A1
(43) Pub. Date: Apr. 20, 2023

(54) DYNAMIC ANTENNA GROUP AND TERMINAL DEVICE COMPRISING SAME

(71) Applicant: ZTE CORPORATION, Shenzhen (CN)

(72) Inventor: Ju TANG, Shenzhen (CN)

(21) Appl. No.: 17/995,623

(22) PCT Filed: May 8, 2021
(86) PCT No.: PCT/CN2021/092473

§ 371 Date: Oct. 6, 2022

(30) Foreign Application Priority Data
Jun. 12, 2020 (CN) 202010534751.7

(51) Int. Cl. H01Q 5/307; H01Q 1/24; H01Q 1/50

(52) U.S. Cl. CPC H01Q 5/307; H01Q 1/242; H01Q 1/50

(57) ABSTRACT

Disclosed are a dynamic antenna group and a terminal device including the same. The dynamic antenna group may be applied to a terminal device, and include: at least two antenna radiators; and a coupling radiator, coupled with the at least two antenna radiators, a tuning component is arranged between the coupling radiator and an electrical ground.

### CROSS-REFERENCE TO RELATED APPLICATION

This application is a national stage filing under 35 U. S. C. § 371 of international application number PCT/CN2021/092473, filed May 8, 2021, which claims priority to Chinese patent application No. 202010534751.7, filed Jun. 12, 2020. The contents of these applications are incorporated herein by reference in their entirety.

### TECHNICAL FIELD

Embodiments of the present disclosure relate to, but not limited to, the technical field of 5G terminal devices, and more particularly, to a dynamic antenna group and a terminal device comprising the same.

### BACKGROUND

With the advent of the 5G era, 5G terminals will become more and more popular. However, because 5G terminals need to be compatible with many frequency bands, the number of antennas has increased dramatically, from 3 to 5 normally used for a 4G terminal to 10 to 15 or even more for a 5G terminal, which pose a higher requirement for 5G terminals aiming at miniaturization and thinness. in view of this, how to reduce a space occupied by antennas and optimize the performance of all antennas in a limited space has become an urgent problem to be addressed.

### SUMMARY

The following is an overview of the subject described in detail herein. This overview is not intended to limit the scope of protection of the claims.

In accordance with an aspect of the present disclosure, an embodiment provides a dynamic antenna group and a terminal device including the same, which aims to address one of related technical problems at least to some extent, including solving the problems of a large number of antennas in the terminal device and insufficient antenna space, so as to optimize the performance of antennas in a limited space.

In accordance with another aspect of the present disclosure, an embodiment provides a dynamic antenna group applied to a terminal device. The dynamic antenna group includes: at least two antenna radiators; and a coupling radiator coupled with the at least two antenna radiators respectively, where a tuning component is arranged between the coupling radiator and an electrical ground.

In accordance with another aspect of the present disclosure, an embodiment provides a terminal device. The device includes: at least one dynamic antenna group as described above.

Other features and advantages of the present invention will be set forth in the following description, and partly become apparent from the description, or understood by practicing the present disclosure. The objects and other advantages of the present disclosure may be realized and obtained by the structure particularly illustrated in the description, claims and drawings.

### BRIEF DESCRIPTION OF DRAWINGS

The drawings are used to provide a further understanding of the technical schemes of the present disclosure and constitute a part of the description. The drawings are used in conjunction with the embodiments of the present disclosure to illustrate the technical schemes of the present disclosure and do not constitute a limitation on the technical schemes of the present disclosure.

FIG. 1 is a schematic structural diagram of a terminal device provided by an embodiment of the present disclosure;

FIG. 2 is a schematic structural diagram of a terminal device provided by another embodiment of the present disclosure; and

FIG. 3 is a schematic structural diagram of a terminal device provided by another embodiment of the present disclosure.

### DETAILED DESCRIPTION

In order to make the objects, technical schemes and advantages of the present disclosure clear, the present disclosure will be further described in detail with reference to the drawings and embodiments. It should be understood that the specific embodiments described here are only used to illustrate the present disclosure, and are not used to limit the present disclosure.

It should be noted that although functional modules are divided in the schematic diagram of the apparatus, and logical orders have been shown in the flowcharts, in some cases, the modules may be divided in a different manner, or the steps shown or described may be executed in an order different from the orders as shown in the flowcharts.

Currently, the antennas adopted in a terminal device have fixed antenna radiators. The terminal device has a plurality of different antennas, but each antenna has a corresponding and fixed antenna radiator. In some cases, a dynamic antenna refers to adding a variable capacitor or a switch to a fixed antenna radiator, and shifting antenna resonance by changing a state of the variable capacitor or the switch to achieve a purpose of antenna tuning. However, such a scheme requires a good radiation efficiency of the antenna radiator, that is, a space area occupied by the antenna radiator may meet basic requirements of a corresponding frequency. In other words, a large space is required. Requirements of such large space often cannot be met in existing terminal devices, especially in 5G terminals.

Embodiments of the present disclosure provide a dynamic antenna group and a terminal device including same. An independent coupling radiator is arranged near two antennas of the terminal device, and the coupling radiator is mutually coupled with inherent antenna radiators of two nearby antennas. The impedance, current magnitude and direction of the coupling radiator are changed by switching a state of a tuning component, thereby changing the resonance frequency and radiation performance of the two nearby antennas to achieve an effect of dynamic tuning. In this way, the coupling radiator dynamically tunes the two nearby antennas, which can effectively reduce an antenna space originally required by the two antennas on the one hand, and can effectively improve the radiation performance of the antennas on the other hand, so that the performance of antennas can be optimized in a limited space.

The embodiments of the present disclosure will be further illustrated below.

An embodiment of the present disclosure provides a dynamic antenna group. The dynamic antenna group is applied to a terminal device, and includes at least two antenna radiators and a coupling radiator. The coupling radiator is coupled with the at least two antenna radiators respectively, and a tuning component is arranged between the coupling radiator and an electrical ground. There are many antennas in the terminal device, for example, 2/3/4G main antenna, 2/3/4G diversity antenna, LTE4*4mimo antenna, 5G nR main antenna, nR diversity antenna, nR 4*4mimo antenna, GPS antenna, WIFI antenna, WIFI mimo and other antennas. Each antenna has a respective antenna radiator electrically connected to an RF signal feeding point of the antenna. The coupling radiator and the antenna radiators in the terminal device may not be connected, but may be mutually coupled. The independently arranged coupling radiator, which has no RF signal feed, is electrically connected with the ground of the terminal device through the tuning component. In the embodiment, the independently arranged coupling radiator may be coupled and multiplexed as a part of the antenna radiators. It should be pointed out that the coupling radiator may be composed of a continuous metal body, or may be formed by connecting multiple metal bodies in series, which is limited in the embodiment.

In an embodiment, the coupling radiator is a radiation arm arranged adjacent to the antenna radiators. For example, in the terminal device, the coupling radiator may be arranged in the middle or near inherent radiators of two adjacent antennas, and the coupling radiator may dynamically tune two nearby antennas in the form of a radiation arm, which can effectively reduce an antenna space originally required by the two antennas on the one hand, and can effectively improve the radiation performance of the antennas on the other hand.

In an embodiment, the impedance, current magnitude and direction of the coupling radiator are changed by switching a state of a tuning component, thereby changing the resonance frequency and radiation performance of the two nearby antennas to achieve an effect of dynamic tuning.

In an embodiment, the coupling radiator may be dynamically coupled and multiplexed as a part of two antennas, so the three form a dynamic antenna group. In a certain scenario, the coupling radiator acts together with an antenna radiator of one of the two antennas to optimize the performance is optimized. In a certain scenario, the coupling radiator acts together with an antenna radiator of the other antenna to optimize the performance is optimized. In a certain scenario, the coupling radiator acts together with the antenna radiators of the two antennas to achieve an optimized balance of performance of the two antennas at the same time. In this way, the coupling radiator dynamically tunes the two nearby antennas, which can effectively reduce an antenna space originally required by the two antennas on the one hand, and can effectively improve the radiation performance of the antennas on the other hand. It should be pointed out that the coupling radiator can not only dynamically tune two nearby antennas, but also dynamically tune more than two nearby antennas.

In an embodiment, the coupling radiator may be in the form of a metal frame, a single embedded metal strip, or a Flexible Printed Circuit, (FPC) or may be formed by means of a printing process (Printing Direct Structuring (PDS), Laser Direct Structuring (LDS)) on a plastic structural component, which will not be particularly limited in the embodiment. The coupling radiator may be set to different sizes, lengths, thicknesses and shapes according to the set frequency bands and performance requirements of the two nearby antennas. In addition, a relative position between the independent radiator and the inherent antenna radiators of the two nearby antennas and a distance between the independent radiator and the inherent antenna radiators may be set based on the frequency bands and performance requirements of the antennas.

In an embodiment, in the terminal device, similarly, the antenna radiator may be in the form of a metal frame, a single embedded metal strip, or an FPC, or may be formed by means of a printing process (PDS, LDS) on a plastic structural component, which will not be particularly limited in the embodiment.

In an embodiment, the tuning component includes at least one of a switch device, a variable capacitor and a tuner. That is, the tuning component may select one of the switch device, the variable capacitor and the tuner for use or select a combination of any of the switch device, the variable capacitor and the tuner, and the number of any of the switch device, the variable capacitor and the tuner may be one or more. The switch device refers to a switch with at least three switching states. For example, the coupling radiator may be electrically connected to the ground of the terminal device through a switch device, a variable capacitor and a tuner. The impedance, current magnitude and direction of the coupling radiator are changed by switching between different states of the switch device, the variable capacitor and the tuner, thereby changing the resonance frequency and radiation performance of the two nearby antennas to achieve an effect of dynamic tuning. It should be pointed out that the switch device, the variable capacitor and the tuner may be respectively arranged at different positions such as two ends or the middle of the radiator.

In an embodiment, the coupling radiator may be formed by connecting a plurality of metal bodies in series, and the plurality of metal bodies are electrically connected with each other through a first connection component. The first connection component includes at least one of a switch device, a variable capacitor, an LC device and a tuner. That is, the first connection component may select one of the switch device, the variable capacitor, the LC device and the tuner for use or may select a combination of any of the switch device, the variable capacitor, the LC device and the tuner, and the number of any of the switch device, the variable capacitor, the LC device and the tuner may be one or more. The switch device refers to a switch with at least three switching states. For example, two or more metal bodies are connected in series by a switch device or a variable capacitor. The impedance of the coupling radiator may be adjusted by changing the switch device or the variable capacitor, thereby changing the resonance frequency and radiation performance of the two nearby antennas to achieve an effect of dynamic tuning. For another example, two or more metal bodies are connected by an LC device, where the LC device may construct a required frequency selection network. For different frequency bands, current may pass through one or two metal bodies, so that a length of the coupling radiator can be dynamically selected to change the resonance frequency and radiation performance of the two nearby antennas to achieve the effect of dynamic tuning.

To sum up, an independent coupling radiator is arranged near two antennas of the terminal device, and the coupling radiator is mutually coupled with inherent antenna radiators of two nearby antennas. The impedance, current magnitude and direction of the coupling radiator are changed by switching a state of a tuning component, thereby changing the resonance frequency and radiation performance of the two nearby antennas to achieve an effect of dynamic tuning. In this way, the coupling radiator, as a dynamic radiation arm, dynamically tunes the two nearby antennas, which can effectively reduce an antenna space originally required by the two antennas on the one hand, and can effectively improve the radiation performance of the antennas on the other hand, so that the performance of antennas can be optimized in a limited space.

In addition, another embodiment of the present disclosure further provides a terminal device. The terminal device includes at least one dynamic antenna group. That is, one dynamic antenna group or multiple dynamic antenna groups may be arranged in the terminal device. It should be pointed out that the terminal device includes, but is not limited to, a mobile phone, a Portable Android Device (PAD), a watch and other electronic products.

Various embodiments of the specific structure of the terminal device will be described below.

In an embodiment, the terminal device further includes a metal frame on which the dynamic antenna group is arranged, that is, the at least two antenna radiators and the coupling radiator are all arranged on the metal frame.

In an embodiment, the terminal device further includes a metal frame and a support, and the support is arranged adjacent to the metal frame. The at least two antenna radiators are arranged on the metal frame, and the coupling radiator is arranged on the support.

In an embodiment, the terminal device further includes a support on which the dynamic antenna group is arranged, that is, the at least two antenna radiators and the coupling radiator are all arranged on the support.

In an embodiment, the coupling radiator is configured to tune with the antenna radiators according to a set state of the tuning component to adjust an operating state of a corresponding antenna. In the terminal device, by switching the set state of the tuning component, the coupling radiator is configured to tune with the adjacent antenna radiators to adjust an operating state of a corresponding antenna accordingly. Therefore, the coupling radiator arranged in the terminal device can effectively reduce a space originally required by the antennas, and can effectively improve the performance of antennas.

In an embodiment, the set state of the tuning component includes a first state, a second state and a third state, and the at least two antenna radiators include a first antenna radiator and a second antenna radiator.

When the tuning component is set to the first state, the coupling radiator is configured to tune with the first antenna radiator to arrange a first antenna into a first resonance state. In the embodiment, in the terminal device, when the first antenna operates, the tuning component is set to the first state, and the coupling radiator acts together with the first antenna radiator to generate resonance to allow the first antenna to achieve an optimized operating state.

When the tuning component is set to the second state, the coupling radiator is configured to tune with the second antenna radiator to arrange a second antenna into a second resonance state. In the embodiment, in the terminal device, when the second antenna operates, the tuning component is set to the second state, and the radiator acts together with the second antenna radiator to generate resonance to allow the second antenna to achieve an optimized operating state.

When the tuning component is set to the third state, the coupling radiator is configured to tune with the first antenna radiator and the second antenna radiator respectively to arrange the first antenna and the second antenna into an equilibrium state. In the embodiment, in the terminal device, when the first antenna and the second antenna may operate at the same time, the tuning component is set to the third state, and the radiator, as a dynamic radiation arm, performs tuning with the first antenna radiator and the second antenna radiator respectively, to allow the first antenna and the second antenna to achieve an optimized equilibrium operating state.

Hereinafter, a detailed description of various embodiments will be made by taking a mobile phone as an example with reference to the drawings.

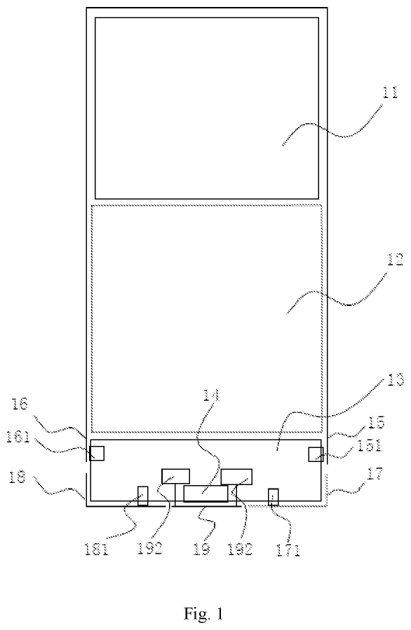

As shown in FIG. 1, FIG. 1 is a schematic structural diagram of a terminal device provided by an embodiment of the present disclosure. The terminal device is a mobile phone with a metal frame. The terminal device includes a main board 11, a battery 12, a sub-board 13, a USB interface 14, an n78/n79 mimo antenna radiator 15, an LTE mimo antenna radiator 16, a 2/3/4G main antenna radiator 17, an n41/n78/n79DRx antenna radiator 18 and a coupling radiator 19. In the embodiment, the n78/n79 mimo antenna radiator 15, the LTE mimo antenna radiator 16, the 2/3/4G main antenna radiator 17, the n41/n78/n79DRx antenna radiator 18 and the coupling radiator 19, serving as a radiation arm, are all arranged on the metal frame of the mobile phone, and are independent of each other without connection. 151 denotes an RF signal feeding point of the n78/n79 mimo antenna radiator 15, 161 denotes an RF signal feeding point of the LTE mimo antenna radiator 16, 171 denotes an RF signal feeding point of the 2/3/4G main antenna radiator 17, and 181 denotes an RF signal feeding point of the n41/n78/n79DRx antenna radiator 18. The coupling radiator 19, existing independently in the form of a radiation arm, is located between the 2/3/4G main antenna radiator 17 and the n41/n78/n79DRx antenna radiator 18, but is not connected with the 2/3/4G main antenna radiator 17 and the n41/n78/n79DRx antenna radiator 18. The coupling radiator 19, as a radiation arm, is electrically connected with the ground of the sub-board 13 through a tuner 191 and a tuner 192. When the mobile phone operates in a voice call state or in a 2/3/4G data service state, that is, when only the 2/3/4G main antenna operates, the tuner 191 and the tuner 192 are both set to the first state, and the coupling radiator 19, as a radiation arm, acts together with the 2/3/4G main antenna radiator 17 to optimize the performance of the 2/3/4G main antenna. When the mobile phone operates in a 5G NR state alone, the tuner 191 and the tuner 192 are both set to the second state, and the coupling radiator 19, as a radiation arm, acts together with the n41/n78/n79DRx antenna radiator 18 to optimize the performance of the n41/n78/n79DRx antenna. When the mobile phone operates in an LTE and nR ENDC scenario, that is, when the 2/3/4G main antenna and the n41/n78/n79DRx antenna may operate at the same time, the tuner 191 and the tuner 192 are both set to the third state, and the coupling radiator 19, as a radiation arm, acts together with the 2/3/4G main antenna radiator 17 and the n41/n78/n79DRx antenna radiator 18 to allow the two antenna radiators of the 2/3/4G main antenna and the n41/n78/n79DRx antenna to achieve an optimized equilibrium state. Since the mobile phone is internally provided with the coupling radiator 19 which exists independently in the form of a radiation arm, both the 2/3/4G main antenna and the n41/n78/n79DRx antenna can be set shorter than in a conventional scheme, so that a space originally required by the 2/3/4G main antenna and the n41/n78/n79DRx antenna can be effectively reduced, and the performance of these two antennas can be effectively improved.

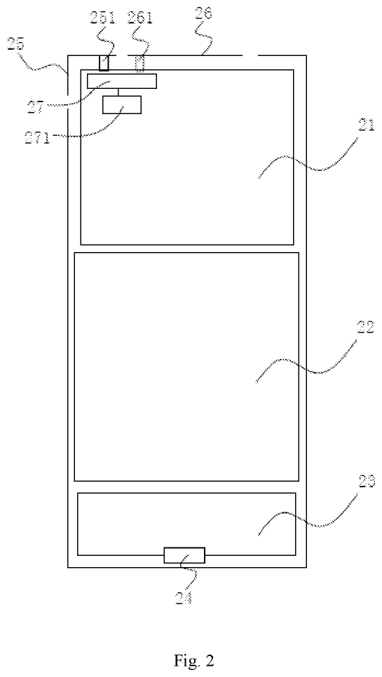

As shown in FIG. 2, FIG. 2 is a schematic structural diagram of a terminal device provided by an embodiment of the present disclosure. The terminal device is a mobile phone with a metal frame. The terminal device includes a main board 21, a battery 22, a sub-board 23, a USB interface 24, a GPS/WIFI antenna radiator 25, a 2/3/4G diversity antenna radiator 26 and a coupling radiator 27. The GPS/WIFI antenna radiator 25 is arranged on the metal frame, and 251 denotes an RF signal feeding point of the antenna radiator. The 2/3/4G diversity antenna radiator 26 is also arranged on the metal frame, and 261 denotes an RF signal feeding point of the antenna radiator. The coupling radiator 27, existing independently in the form of a radiation arm, is arranged on the support in the form of LDS, and is not connected with the GPS/WIFI antenna radiator 25 and the 2/3/4G diversity antenna radiator 26. The coupling radiator 27, as a radiation arm, is arranged adjacent to the GPS/WIFI antenna radiator 25 and the 2/3/4G diversity antenna radiator 26. The coupling radiator 27, as a radiation arm, is electrically connected to the ground of the main board 21 through a switch 271. When the mobile phone operates in a WIFI surfing scenario and the like, that is, when only the GPS/WIFI antenna operates, the switch 271 is set to the first state, and the coupling radiator 27, as a radiation arm, acts together with the GPS/WIFI antenna radiator 25 to optimize the performance of the 2GPS/WIFI antenna. When the mobile phone operates in a 4G network surfing scenario, that is, when only the 2/3/4G diversity antenna operates, the switch 271 is set to the second state, and the coupling radiator 27, as a radiation arm, acts together with the 2/3/4G diversity antenna radiator 26 to optimize the performance of the 2/3/4G diversity antenna. When the mobile phone operates in a navigation state or in a WIFI hotspot starting and 4G network surfing scenario, that is, when the GPS/WIFI antenna and the 2/3/4G diversity antenna operate at the same time, the switch 271 is set to the third state, and the coupling radiator 27, as a radiation arm, acts together with the GPS/WIFI antenna radiator 25 and the 2/3/4G diversity antenna radiator 26 to allow both the GPS/WIFI antenna and the 2/3/4G diversity antenna to achieve an optimized equilibrium state. Since the mobile phone is internally provided with a coupling radiator 27 which exists independently in the form of a radiation arm, a space originally required by the GPS/WIFI antenna and the 2/3/4G diversity antenna radiator can be effectively compressed and the performance of the two antennas can be effectively improved.

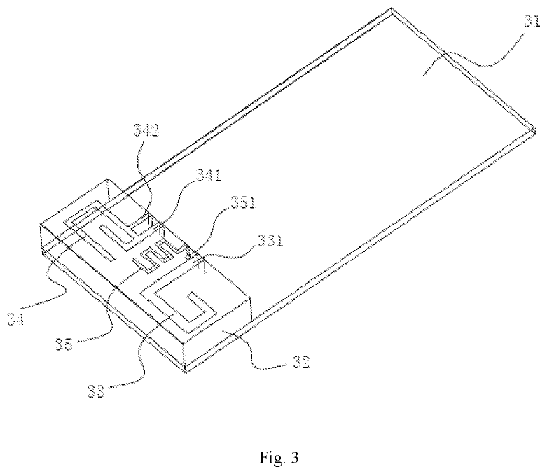

As shown in FIG. 3, FIG. 3 is a schematic structural diagram of a terminal device provided by an embodiment of the present disclosure. The terminal device includes a main board 31, a support 32, an n78/n79 antenna radiator 33, a GPS/WIFI/MHB antenna radiator 34 and a coupling radiator 35. The n78/n79 antenna radiator 33 is arranged on the support 32 by means of LDS, and 331 denotes an RF signal feeding point of the antenna radiator, which is connected with a circuit the main board 31. The GPS/WIFI/MHB antenna radiator 34 is also arranged on the support 32 by means of LDS, 341 denotes an RF signal feeding point of the antenna radiator, which is connected with the circuit the main board 31, and 342 denotes a location of the antenna radiator, which is connected with the ground of the main board 31. The coupling radiator 35, existing independently in the form of a radiation arm, is arranged on the support by means of LDS, and is not connected with the n78/n79 antenna radiator 33 and the GPS/WIFI/MHB antenna radiator 34. 351 denotes a switch arranged on the main board 31, and a dynamic radiation arm, denoted by 35, is electrically connected with the ground of the main board 31 through the switch 351. When the mobile phone operates in a scenario such as WIFI surfing, that is, when only the GPS/WIFI/MHB antenna operates, the switch 351 is set to the first state, and the coupling radiator 35, as a radiation arm, acts together with the GPS/WIFI/MHB antenna radiator 34 to optimize the performance of the GPS/WIFI/MHB antenna. When the terminal operates in a 5G network surfing scenario, that is, when only the n78/n79 antenna operates, the switch 351 is set to the second state, and the coupling radiator 35, as a radiation arm, acts together with the n78/n79 antenna radiator 33 to optimize the performance of the n78/n79 antenna. When the terminal operates in a navigation state or in a WIFI hotspot starting and 5G network surfing or 4G and 5G ENDC scenario, that is, when the GPS/WIFI/MHB antenna and the n78/n79 antenna operate at the same time, the switch 351 is set to the third state, and the coupling radiator 35, as a radiation arm, acts together with the n78/n79 antenna radiator 33 and the GPS/WIFI/MHB antenna radiator 34 to allow both the n78/n79 antenna and the GPS/WIFI antenna to achieve an optimized equilibrium state. Since the mobile phone is internally provided with a coupling radiator 35 which exists independently in the form of a radiation arm, a space originally required by the two antenna radiators can be effectively compressed and the performance of the two antenna radiators can be effectively improved.

According to embodiments of the present disclosure, an independent coupling radiator is arranged near two antennas of the terminal device, and the coupling radiator is mutually coupled with inherent antenna radiators of two nearby antennas. The impedance, current magnitude and direction of the coupling radiator are changed by switching a state of a tuning component, thereby changing the resonance frequency and radiation performance of the two nearby antennas to achieve an effect of dynamic tuning. In this way, the coupling radiator dynamically tunes the two nearby antennas, which can effectively reduce an antenna space originally required by the two antennas on the one hand, and can effectively improve the radiation performance of the antennas on the other hand, so that the performance of antennas can be optimized in a limited space.

The above is a detailed description of some embodiments of the present disclosure, but the present disclosure is not limited thereto. Those having ordinary skills in the art can also make various equivalent modifications or substitutions without violating the protection scope of the disclosure, and these equivalent modifications or substitutions are all included in the scope defined by the claims of the present disclosure.

1. A dynamic antenna group, applied to a terminal device, comprising:
at least two antenna radiators; and
a coupling radiator, coupled with the at least two antenna radiators, wherein a tuning component is arranged between the coupling radiator and an electrical ground.

2. The dynamic antenna group of claim 1, wherein the coupling radiator is a radiation arm which is arranged adjacent to the antenna radiators.

3. The dynamic antenna group of claim 1, wherein the tuning component comprises at least one of the following:
a switch device;
a variable capacitor; and
a tuner.

4. The dynamic antenna group of claim 1,
wherein the coupling radiator is composed of a continuous metal body; or
the coupling radiator is formed by connecting at least two metal bodies in series,
the at least two metal bodies being electrically connected through a first connection component, and
the first connection component comprising at least one of the following:
a switch device;
a variable capacitor;
an LC device; and
a tuner.

5. A terminal device, comprising:
at least one dynamic antenna group, the dynamic antenna group, applied to a terminal device, comprising:
at least two antenna radiators; and
a coupling radiator, coupled with the at least two antenna radiators, wherein a tuning component is arranged between the coupling radiator and an electrical ground.

6. The terminal device of claim 5, further comprising:
a metal frame, wherein:
the dynamic antenna group is arranged on the metal frame.

7. The terminal device of claim 5, further comprising:
a metal frame; and
a support adjacent to the metal frame, wherein:
the antenna radiators are arranged on the metal frame, and the coupling radiator is arranged on the support.

8. The terminal device of claim 5, further comprising:
a support, wherein:
the dynamic antenna group is arranged on the support.

9. The terminal device of claim 6, wherein the coupling radiator is configured to tune with the antenna radiators according to a set state of the tuning component to adjust an operating state of a corresponding antenna.

10. The terminal device of claim 9, wherein the set state of the tuning component comprises a first state, a second state and a third state, and
the at least two antenna radiators comprise a first antenna radiator and a second antenna radiator,
the coupling radiator is configured to tune with the antenna radiators according to a set state of the tuning component to adjust an operating state of a corresponding antenna comprises:
in response to the tuning component being set to the first state, the coupling radiator is configured to tune with the first antenna radiator to arrange a first antenna into a first resonance state;
in response to the tuning component being set to the second state, the coupling radiator is configured to tune with the second antenna radiator to arrange a second antenna into a second resonance state; and
in response to the tuning component being set to the third state, the coupling radiator is configured to tune with the first antenna radiator and the second antenna radiator respectively to arrange the first antenna and the second antenna into an equilibrium state.

11. The dynamic antenna group of claim 2, wherein the tuning component comprises at least one of the following:
a switch device;
a variable capacitor; and
a tuner.

12. The dynamic antenna group of claim 2, wherein the coupling radiator is composed of a continuous metal body; or
the coupling radiator is formed by connecting at least two metal bodies in series,
the at least two metal bodies being electrically connected through a first connection component, and
the first connection component comprising at least one of the following:
a switch device;
a variable capacitor;
an LC device; and
a tuner.

13. The terminal device of claim 7, wherein the coupling radiator is configured to tune with the antenna radiators according to a set state of the tuning component to adjust an operating state of a corresponding antenna.

14. The terminal device of claim 8, wherein the coupling radiator is configured to tune with the antenna radiators according to a set state of the tuning component to adjust an operating state of a corresponding antenna.
